(19) United States
(12) Patent Application Publication
(10) Pub. No.: US 2016/0088476 A1
(43) Pub. Date: Mar. 24, 2016

(54) ELECTRONIC DEVICE, ACCESSORY DEVICE, AND METHOD OF AUTHENTICATING ACCESSORY DEVICE

(71) Applicant: Samsung Electronics Co., Ltd., Suwon-si (KR)

(72) Inventors: Seo-Yeon PARK, Hwaseong-si (KR); Hyung-Wook JANG, Suwon-si (KR)

(21) Appl. No.: 14/861,507

(22) Filed: Sep. 22, 2015

(30) Foreign Application Priority Data
Sep. 23, 2014 (KR) 10-2014-0127027

(51) Int. Cl. H04W 12/06; H04W 4/00

(52) U.S. Cl. CPC H04W 12/06; H04W 4/008

(57) ABSTRACT

An electronic device, an accessory device, and a method of authenticating an accessory device are provided. The electronic device includes a detection sensor that detects connection of an accessory device, an Radio Frequency (RF) module that transmits and receives a radio-frequency signal, and a processor that makes a control to transmit an authentication request signal through the RF module when the connection of the accessory device is detected, and performs authentication with the accessory device when an authentication request response signal is received from the accessory device.

### CROSS-REFERENCE TO RELATED APPLICATION(S)

This application claims the benefit under 35 U.S.C. §119(a) of a Korean patent application filed on Sep. 23, 2014 in the Korean Intellectual Property Office and assigned Serial number 10-2014-0127027, the entire disclosure of which is hereby incorporated by reference.

### TECHNICAL FIELD

The present disclosure relates to an electronic device and an accessory device. More particularly, the present disclosure relates to a method of authenticating an accessory device by an electronic device.

### BACKGROUND

With the remarkable development of information and communication technologies and semiconductor technologies, an extent and use of various types of electronic devices are increasing rapidly. In particular, current electronic devices are being developed such that users may communicate with others while carrying them.

The electronic devices, such as smart phones, personal computers, and tablet PCs, provide users with various useful functions through a variety of applications. The electronic devices are changing into devices that users may use to gather various types of information through the provision of various functions in addition to using for a voice call.

Currently, accessory devices that perform some functions of an electronic device are operated in conjunction with the electronic device while being connected thereto have been developed and may be used together with the electronic device. For example, accessory devices may include various devices such as a protective cover for protecting an electronic device, a dock on which an electronic device may be placed, a charger for charging an electronic device, and the like.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide electronic devices and accessory devices have been used without interworking authentication therebetween or have been used after being authenticated while being physically connected to each other.

However, when electronic devices and accessory devices are used without interworking authentication there between, counterfeit accessory devices that are not allowed to access the electronic devices may be used. In addition, when accessory devices are authenticated through physical connection with electronic devices, a separate module and a mounting space are necessary for the physical connection, thereby causing inefficiency.

Another aspect of the present disclosure is to provide an electronic device and an accessory device that may perform authentication therebetween through a wireless communication scheme without physical connection therebetween, and a method of authenticating an accessory device by an electronic device.

In addition, another aspect of the present disclosure is to provide an electronic device and an accessory device that may perform authentication therebetween using a security authentication algorithm through a wireless communication scheme, and a method of authenticating an accessory device by an electronic device.

At least one of the aforementioned aspects of the present disclosure may be achieved by configurations that will be described below.

In accordance with an aspect of the present disclosure, an electronic device is provided. The device includes a detection sensor configured to detect a connection of an accessory device, an Radio Frequency (RF) module configured to transmit and receive a radio-frequency signal, and a processor configured to transmit an authentication request signal through the RF module when the connection of the accessory device is detected, and to perform authentication with the accessory device when an authentication request response signal is received from the accessory device.

In accordance with another aspect of the present disclosure, an accessory device is provided. The device includes an RF module configured to transmit and receive a radio-frequency signal, and an Integrated Circuit (IC) configured to transmit an authentication request response signal to an electronic device, and to perform authentication with the electronic device when an authentication request signal is received from the electronic device through the RF module.

In accordance with another aspect of the present disclosure, a method of authenticating an accessory device in an electronic device is provided. The method includes detecting a connection of the accessory device, transmitting an authentication request signal when the connection of the accessory device is detected, receiving an authentication request response signal from the accessory device; and performing authentication with the accessory device.

In accordance with another aspect of the present disclosure, a non-transitory storage medium is provided. The non-transitory storage medium stores thereon a program for authenticating an accessory device is stored, the program executed by an electronic device, performs a method including detecting a connection of the accessory device, transmitting an authentication request signal through an RF module when the connection of the accessory device is detected, receiving an authentication request response signal from the accessory device; and performing authentication with the accessory device.

As described above, according to various embodiments of the present disclosure, an electronic device and an accessory device may perform authentication therebetween through a wireless communication scheme without physical connection therebetween. Thus, the electronic device and the accessory device do not need a separate module and a mounting space for the physical connection therebetween unlike the existing authentication methods, thereby making it possible to reduce the size and manufacturing costs of the electronic device and the accessory device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device and an accessory device according to an embodiment of the present disclosure;

FIG. 2 is a block diagram of an accessory device according to an embodiment of the present disclosure;

FIG. 3 is a block diagram illustrating a network environment including an electronic device according to an embodiment of the present disclosure;

FIG. 4 is a perspective view illustrating an implemented embodiment of an electronic device and an accessory device according to an embodiment of the present disclosure;

FIG. 5 illustrates communication flow for authentication of an electronic device and an accessory device according to an embodiment of the present disclosure;

FIG. 6 is a signal flow diagram specifically illustrating an authentication operation of an electronic device and an accessory device according to an embodiment of the present disclosure;

FIG. 7 is a flowchart illustrating an operation of authenticating an accessory device in an electronic device according to an embodiment of the present disclosure; and

FIG. 8 is a block diagram of an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. For example, the expression “A or B” or “at least A or/and B” may include A, may include B, or may include both A and B.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, both a first electronic device and a second electronic device are electronic devices, and the first and second electronic devices may refer to electronic devices of different users or different devices of the same user. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

The terms in various embodiments of the present disclosure are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art, to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various embodiments of the present disclosure may be devices adopting a communication function. For example, the electronic devices may include at least one of smart phones, tablet personal computers (PCs), mobile phones, video phones, e-book readers, desktop PCs, laptop PCs, netbook computers, personal digital assistants (PDAs), portable multimedia players (PMPs), Moving Picture Experts Group (MPEG-1 or MPEG-2) Audio layer III (MP3) players, mobile medical devices, cameras, wearable devices (e.g., head-mounted-devices (HMDs) such as electronic glasses), electronic clothes, electronic bracelets, electronic necklaces, electronic appcessories, electronic tattoos, or smart watches.

According to an embodiment, an electronic device may be a smart home appliance with a communication function. The smart home appliance as an example of the electronic device may include at least one of a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or a home robot, an automatic teller machine (ATM) of a banking system, and a point of sales (POS) of a shop.

According to another embodiment, the electronic devices may include at least one of furniture or a part of a building/structure having a communication function, electronic boards, electronic signature receiving devices, projectors, or various measuring equipment (e.g., equipment for a water supply, an electricity, gases or radio waves). An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

Hereinafter, an electronic device according to various embodiments of the present disclosure will be described with reference to the accompanying drawings. In various embodiments, the term “user” may indicate a person using an electronic device or a device (e.g., an artificial intelligence electronic device) using an electronic device.

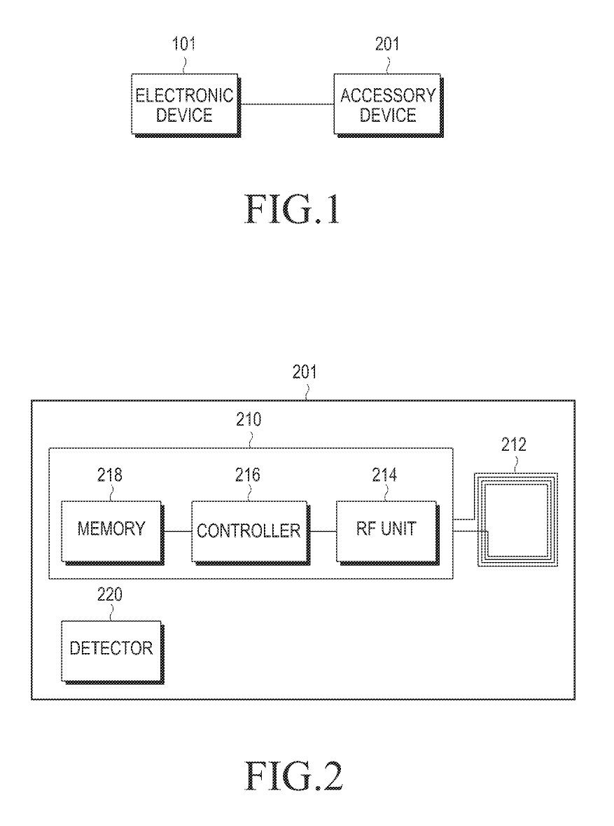

FIG. 1 is a block diagram illustrating an electronic device and an accessory device according to an embodiment of the present disclosure.

Referring to FIG. 1, an electronic device 101 and an accessory device 201 may be connected to each other physically or by using communication and may be operated in conjunction with each other. The electronic device 101 and the accessory device 201 may authenticate each other using a communication scheme following International Organization for Standardization (ISO)/International Engineering Consortium (IEC) 14443 standards or ISO/IEC 15693 communication standards, for example, using a Near Field Communication (NFC) communication scheme or a Radio Frequency Identification (RFID) communication scheme. When the authentication result shows that the accessory device 201 is allowed to access the electronic device 101, the electronic device 101 may control the accessory device 201 to be operated in conjunction therewith. According to an embodiment, when the accessory device 201 is connected to the electronic device 101 physically or by using communication, the electronic device 101 may perform authentication with the accessory device 201 and execute a predetermined function when the authentication for the accessory device 201 succeeds.

FIG. 2 is a block diagram of an accessory device according to an embodiment of the present disclosure.

Referring to FIG. 2, an accessory device 201 may include an Integrated Chip (IC) 210 and an antenna 212.

The IC 210 may include a Radio Frequency (RF) unit 214, a controller 216, and a memory 218. The RF unit 214 may receive a radio signal through the antenna 212. According to an embodiment, the RF unit 214 may receive, through the antenna 212, a radio signal in the frequency band following ISO/IEC 14443 standards or ISO/IEC 15693 communication standards, for example, a radio signal in the NFC frequency band or the RFID frequency band. According to an embodiment, the RF unit 214 may receive a prescribed signal from an external electronic device 101. According to an embodiment, although the prescribed signal is in the frequency band corresponding to ISO 14443 standards or ISO/IEC 15693 standards, the signal may be a signal that is not defined in ISO 14443 standards or ISO/IEC 15693 standards. According to an embodiment, the RF unit 214 may receive a Request Secure (REQS) signal as the signal supported by the external electronic device 101, the REQS signal being a nonstandard protocol signal. The REQS signal may be a signal for requesting authentication of the accessory device 201.

The controller 216 may perform an authentication operation according to an authentication process for authenticating the accessory device 201. The controller 216 may include a Central Processor Unit (CPU) and a crypto co-processor. In addition, the controller may include one or more encryption-related modules of various types in addition to them. The one or more encryption-related modules may include a Random Number Generator (RNG), a Multi-Media Unit (MMU), and an Advanced Encryption Standard (AES), a T-Data Encryption Standard (T-DES).

According to an embodiment, when a signal is received through the RF unit 214, the controller 216 may determine whether the signal corresponds to a prescribed signal for requesting authentication, for example, the REQS signal. When the signal corresponds to the REQS signal, the controller 216 makes a control so that an authentication response signal, for example, an Answer To Request Secure (ATQS) signal is transmitted in response to the REQS signal. According to an embodiment, although the ATQS signal is in the frequency band corresponding to ISO 14443 standards or ISO/IEC 15693 standards, the ATQS signal may be a signal supported by the external electronic device 101 and is not defined in ISO 14443 standards or ISO/IEC 15693 standards. According to an embodiment, the controller 216 may transmit the ATQS signal and then perform authentication through communication with the external electronic device 101.

The memory 218 may store an authentication program for the authentication operation of the controller 216 and data necessary for authentication. The memory 218 may additionally store encryption information required for encrypting data when the authentication is performed. The memory 218 may be a machine (e.g., computer) readable medium, and the term “machine readable medium” may be defined as a medium for providing data to the machine so that the machine may perform a particular function. The machine readable medium may be a storage medium. The memory 218 may include a non-volatile medium or a volatile medium. All such mediums should be of a type that allows instructions transferred by the mediums to be detected by a physical mechanism through which the machine reads the instructions. The machine readable medium may include at least one of Read-Only Memory (ROM), a Random Access Memory (RAM), and a flash memory; however, the present disclosure is not limited thereto. The memory 218 may store encryption information necessary for encrypting data.

According to an embodiment, the accessory device 201 may further include a sensing body 220. The sensing body 220 may be an object or material through which the detection sensor of the electronic device 101 may detect the accessory device 201 connected thereto. According to an embodiment, the sensing body 220 may be a magnetic material, and the detection sensor may be a Hall Integrated Circuit (IC) capable of detecting a magnetic material. According to an embodiment, the sensing body may be a first switch terminal, and the detection sensor may be a second switch terminal of the electronic device 101 capable of contacting the switch terminal of the accessory 201. According to an embodiment, the sensing body may be a contact protrusion, and the detection sensor may be a contact sensor of the electronic device 101 capable of detecting contact with the contact protrusion. In addition, any elements capable of detecting the connection between the accessory device 201 and the electronic device 101 may be used as the sensing body and the detection sensor.

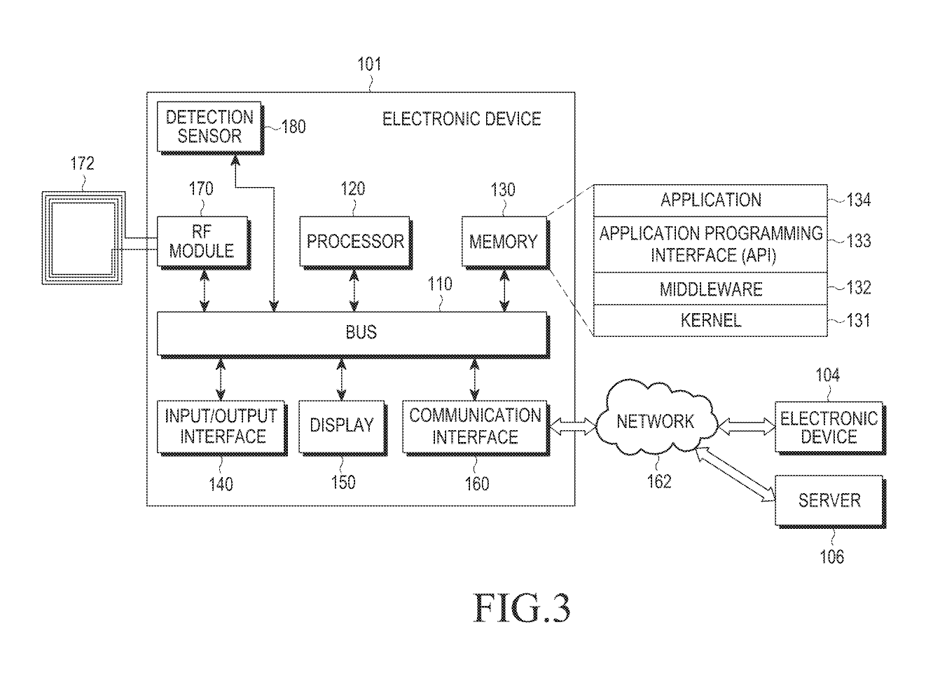

FIG. 3 is a block diagram illustrating a network environment including an electronic device according to various embodiments of the present disclosure.

Referring to FIG. 3, an electronic device 101 may include a bus 110, a processor 120, a memory 130, an input/output interface 140, a display 150, a communication interface 160, an RF module 170, and a detection sensor 180, but is not limited thereto.

The bus 110 may be a circuit for connecting the aforementioned elements and transmitting communication (e.g., a control message) between the aforementioned elements.

For example, the processor 120 may receive instructions from the aforementioned other elements (e.g., the memory 130, the input/output interface 140, the display 150, the communication interface 160, the RF module 170, and the detection sensor 180) through the bus 110, decipher the received instructions, and perform calculation or data processing according to the deciphered instructions. According to an embodiment, the processor 120 may perform calculations or data processing necessary for authentication of an accessory device 201.

The memory 130 may store instructions or data received from or created by the processor 120 or other elements (e.g., the input/output interface 140, the display 150, and the communication interface 160). The memory 130 may include programming modules, for example, a kernel 131, middleware 132, an Application Programming Interface (API) 133, and applications 134. The aforementioned programming modules may be formed of software, firmware, hardware, or a combination of at least two thereof.

The kernel 131 may control or manage system resources (e.g., the bus 110, the processor 120, or the memory 130) used for executing an operation or a function implemented in the remaining other programming modules, for example, the middleware 132, the API 133, or the applications 134. In addition, the kernel 131 may provide an interface through which the middleware 132, the API 133, or the applications 134 may control or manage the individual elements of the electronic device 101 while accessing the individual elements.

The middleware 132 may serve as an intermediary enabling the API 133 or the applications 134 to transfer data through communication with the kernel 131. Furthermore, in regard to task requests received from the applications 134, the middleware 132 may perform a control (e.g., scheduling or load balancing) for the task requests, using a method such as allocating at least one of the applications 134 a priority for using the system resources (e.g., the bus 110, the processor 120, and the memory 130) of the electronic device 101.

The API 133 is an interface through which the applications 134 may control functions provided by the kernel 131 and the middleware 132 and may include at least one interface or function (e.g., instruction) for file control, window control, image processing, or text control.

According to various embodiments, the applications 134 may include a Short Message Service (SMS)/Multimedia Message Service (MMS) application, an e-mail application, a calendar application, an alarm application, a health care application, an environment information application (e.g., an application for providing atmospheric pressure, humidity, or temperature information), and an application for authenticating an accessory device. Additionally or alternatively, the applications 134 may include an application related to an information exchange between the electronic device 101 and an external electronic device (e.g., another electronic device 104). The application related to the information exchange may include, for example, a notification relay application for transferring particular information to the external electronic device or a device management application for managing the external electronic device.

For example, the notification relay application may include a function of transferring, to the external electronic device (e.g., the other electronic device 104), notification information generated in other applications of the electronic device 101 (e.g., a network unlock application, a health care application, an SMS/MMS application, an e-mail application, and an environment information application). Additionally or alternatively, the notification relay application may receive notification information from, for example, the external electronic device (e.g., the other electronic device 104) and provide the received notification information to a user. For example, the device management application may manage (e.g., install, delete, or update) functions for at least a part of the external electronic device (e.g., the other electronic device 104) communicating with the electronic device 101 (e.g., turning on/off the external electronic device itself (or some elements thereof) or adjusting brightness (or resolution) of a display), applications operating in the external electronic device, or services (e.g., a telephone call service or a message service) provided from the external electronic device.

According to various embodiments, the applications 134 may include an application that is dependent upon the attribute (e.g., the type) of the external electronic device (e.g., the other electronic device 104). For example, in the case where the external electronic device is an MP3 player, the applications 134 may include an application related to the reproduction of music. Similarly, in the case where the external electronic device is a mobile medical appliance, the applications 134 may include an application related to health care. According to an embodiment, the applications 134 may include at least one of an application designated to the electronic device 101 and an application received from the external electronic device (e.g., a server 106 or the other electronic device 104).

The input/output interface 140 may transfer instructions or data input from a user through an input/output device (e.g., a sensor, a keyboard, or a touch screen) to the processor 120, the memory 130, and the communication interface 160 through, for example, the bus 110. For example, the input/output interface 140 may provide, to the processor 120, data for a user's touch input through the touch screen. In addition, through the input/output device (e.g., a speaker or a display), the input/output interface 140 may output instructions or data received from the processor 120, the memory 130, or the communication interface 160 through the bus 110. For example, the input/output interface 140 may output voice data, processed through the processor 120, to a user through a speaker.

The display 150 may display various pieces of information (e.g., multimedia data or text data) to a user.

The communication interface 160 may connect communication between the electronic device 101 and the external electronic device (e.g., the other electronic device 104 or the server 106). For example, the communication interface 160 may be connected to a network 162 through wireless or wired communication to communicate with the external device. The wireless communication may include at least one of, for example, Wi-Fi, Bluetooth (BT), Near Field Communication (NFC), Global Positioning System (GPS) and cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), and Global System for Mobile communication (GSM)). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The communication network may include at least one of a computer network, an Internet, the Internet of things, and a telephone network. According to an embodiment, a protocol (e.g., a transport layer protocol, data link layer protocol, or a physical layer protocol) for communication between the electronic device 101 and the external device may be supported by at least one of the applications 134, the application programming interface 133, the middleware 132, the kernel 131, and the communication interface 160.

According to an embodiment, the server 106 may support the driving of the electronic device 101 by performing at least one operation (or function) implemented in the electronic device 101. For example, the server 106 may support an accessory authentication function implemented in the electronic device 101.

The RF module 170 may receive a radio signal through the antenna 172. According to an embodiment, the RF module 170 may be a radio module. According to an embodiment, the RF module 170 may receive, through the antenna 172, a radio signal in the frequency band following ISO/IEC 14443 standards or ISO/IEC 15693 communication standards, for example, a radio signal in the NFC frequency band or the RFID frequency band. According to an embodiment, the RF module 170 may transmit a prescribed signal to the accessory device 201. According to an embodiment, although the prescribed signal is in the frequency band corresponding to ISO 14443 standards or ISO/IEC 15693 standards, the signal may be a signal that is not defined in ISO 14443 standards or ISO/IEC 15693 standards. According to an embodiment, the RF module 170 may transmit a REQS signal as the signal supported by the accessory device 201, the REQS signal being a nonstandard protocol signal. The REQS signal may be a signal for requesting authentication of the accessory device 201. The RF module 170 may receive an authentication response signal, for example, an ATQS signal in response to the REQS signal and transfer the received ATQS signal to the processor 120. According to an embodiment, although the ATQS signal is in the frequency band corresponding to ISO 14443 standards or ISO/IEC 15693 standards, the ATQS signal may be a signal supported by the accessory device 201 and is not defined in ISO 14443 standards or ISO/IEC 15693 standards. According to an embodiment, the processor 120 may receive the ATQS signal and then perform authentication through communication with the accessory device 201.

A detection sensor 180 may detect whether the accessory device 201 is connected to the electronic device 101. According to an embodiment, the detection sensor 180 may detect the sensing body 220 of the accessory device 201. According to an embodiment, the sensing body 220 may be a magnetic material, and the detection sensor 180 may be a Hall IC capable of detecting a magnetic material. According to an embodiment, the sensing body 220 may be a first switch terminal, and the detection sensor 180 may be a second switch terminal capable of being connected to the first switch terminal of the accessory device 201. According to an embodiment, the sensing body 220 may be a contact protrusion, and the detection sensor 180 may be a contact sensor capable of detecting contact with the contact protrusion. In addition, any elements capable of detecting the connection between the accessory device 201 and the electronic device 101 may be used as the detection sensor.

According to an embodiment, the electronic device 101 may authenticate the accessory device 201 one or more times. In addition, according to an embodiment, the electronic device 101 may individually authenticate a plurality of different accessory devices. According to an embodiment, the electronic device 101 may sequentially authenticate a plurality of different accessory devices.

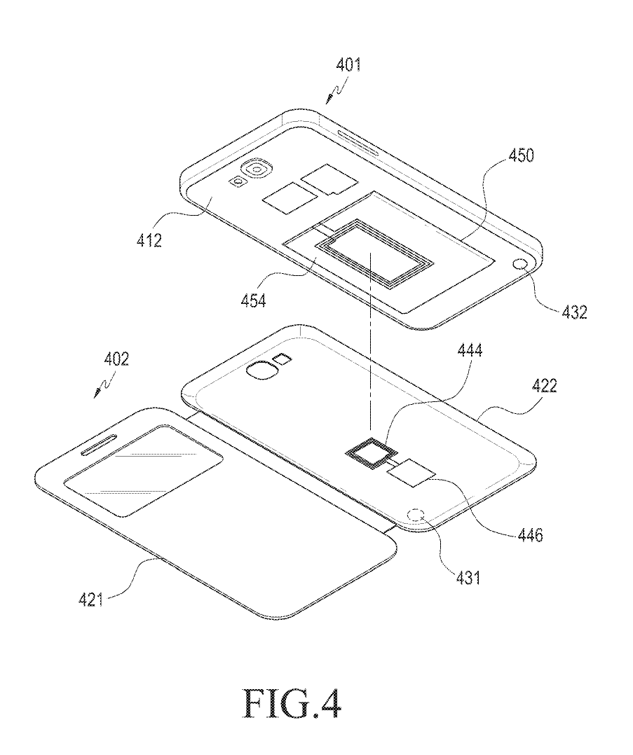

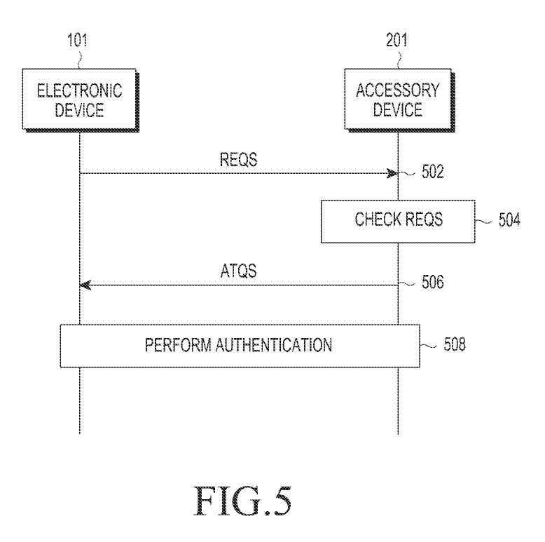

FIG. 4 is a perspective view illustrating an implemented embodiment of an electronic device and an accessory device according to an embodiment of the present disclosure.

Referring to FIG. 4, the electronic device may be a portable terminal 401, and the accessory device may be a protective cover 402 of the portable terminal.

The protective cover 402 of the portable terminal may include a front cover 421 and a rear cover 422. A second NFC antenna 444 and an IC 446 may be disposed on a side of the rear cover 422. A sensing body 431 may be additionally disposed on a side of the rear cover 422.

The portable terminal 401 may include a first antenna 454 placed on the rear surface 412 thereof. According to an embodiment, the first NFC antenna 454 may be placed on a battery 450 mounted on the rear surface 412 of the portable terminal 401. The portable terminal 401 may further include a detection sensor 432 placed on the rear surface 412 thereof.

The rear cover 422 may have a structure where the rear surface 412 of the portable terminal 401 may be coupled, seated, or connected, and the portable terminal 401 may be coupled to, seated on, or connected to the rear cover 422. When the portable terminal 401 is seated on, or coupled or connected to the rear cover 422, the sensing body 431 may be detected by the detection sensor 432.

As the sensing body 431 is detected by the detection sensor 432, the portable terminal 401 may determine that the protective cover 402 has been connected thereto. When it is determined that the portable terminal 401 has been connected to the protective cover 402, the portable terminal 401 may transmit a REQS signal through the first antenna 454. The protective cover 402 may receive the REQS signal through the second antenna 444. When the REQS signal is received, the IC 446 may transmit an ATQS signal through the second antenna 444. When the ATQS signal is received through the first antenna 454, the portable terminal 401 may perform an authentication operation through communication with the protective cover 402.

According to an embodiment, the first and second antennas 454 and 444 may overlap each other to enhance communication efficiency when the portable terminal 401 is coupled to, seated on, or connected to the rear cover 422. As the first and second antennas overlap each other when the portable terminal 401 is coupled to, seated on, or connected to the rear cover 422, the second antenna 444 may not affect the first antenna 454 when the first antenna 454 performs an NFC operation, thereby preventing a decrease in performance of the NFC operation of the first antenna 454.

FIG. 5 illustrates communication flow for authentication of an electronic device and an accessory device according to an embodiment of the present disclosure.

Referring to FIG. 5, in operation 502, an electronic device 101 may transmit a signal for requesting authentication to an accessory device 201. According to an embodiment, the signal for requesting authentication, which is a prescribed signal, may be a REQS signal. According to an embodiment, although the REQS signal is in the frequency band corresponding to ISO/IEC 14443 standards or ISO/IEC 15693 standards, the REQS signal may be a signal that is not defined in ISO 14443 standards or ISO/IEC 15693 standards.

In operation 504, the accessory device 201 may check the REQS signal. According to an embodiment, the accessory device 201 may check whether the received signal corresponds to the prescribed REQS signal.

When the received signal corresponds to the prescribed REQS signal, the accessory device 201 may transmit a prescribed ATQS signal as a response signal for the authentication request, in operation 506. According to an embodiment, although the ATQS signal is in the frequency band corresponding to ISO 14443 standards or ISO/IEC 15693 standards, the ATQS signal may be a signal supported by the electronic device 101, the signal being not defined in ISO 14443 standards or ISO/IEC 15693 standards.

When the ATQS signal is received, the electronic device 101 may perform authentication through communication with the accessory device 201, in operation 508.

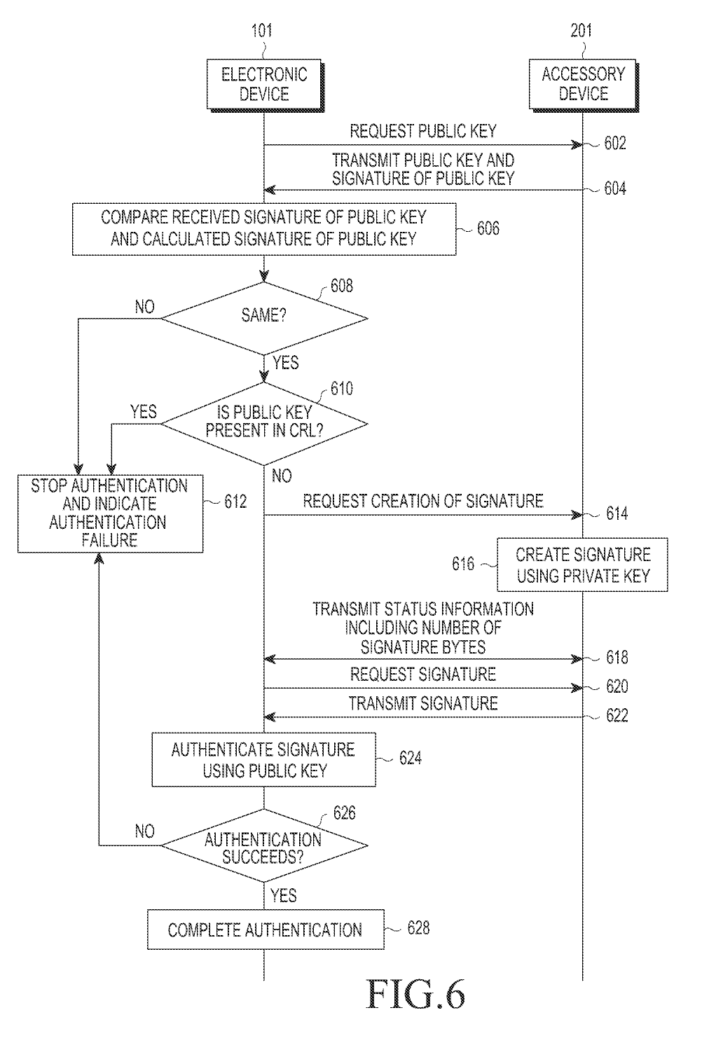

FIG. 6 is a signal flow diagram specifically illustrating an authentication operation of an electronic device and an accessory device according to an embodiment of the present disclosure;

Referring to FIG. 6, in operation 602, an electronic device 101 may request a public key from an accessory device 201. In operation 604, the accessory device 201 may transmit a pre-stored public key and a signature of the public key to the electronic device. In operation 606, the electronic device 101 may compare the received signature of the public key with a calculated signature of the public key. In operation 608, the electronic device 101 may determine whether the received signature of the public key is the same as the calculated signature of the public key. If not, the electronic device 101 may stop the authentication and indicate that the authentication failed, in operation 612. When it is determined that the received signature of the public key is the same as the calculated signature of the public key, the electronic device 101 may determine whether the public key is present in a Certificate Revocation List (CRL), in operation 610. When it is determined that the public key is present in the CRL, the electronic device 101 may stop the authentication and indicate that the authentication failed, in operation 612. When it is determined that the public key does not exist in the CRL, the electronic device 101 may request the accessory device 201 to create a signature, in operation 614.

In operation 616, the accessory device 201 may create the signature using a private key. In operation 618, the accessory device 201 may transmit status information including the number of signature bytes to the electronic device 101.

In operation 620, the electronic device 101 may request the signature, and in operation 622, the accessory device 201 may transmit the signature to the electronic device 101.

According to an embodiment, the accessory device 201 may transmit the signature to the electronic device 101 and then terminate the operation thereof. When the operation of the accessory device 201 is terminated, the accessory device 201 may be in a sleep state. The accessory device 201 in the sleep state may not have any influence on the electronic device 101. Thereafter, if a REQS signal is received again, the accessory device 201 may be activated to perform an authentication process.

In operation 624, the accessory device 101 may authenticate the signature using the private key. In operation 626, the electronic device 101 may determine whether the authentication succeeds.

When the authentication fails, the electronic device 101 may stop the authentication and indicate that the authentication failed, in operation 612. When the authentication succeeds, the electronic device 101 may complete the authentication, in operation 628.

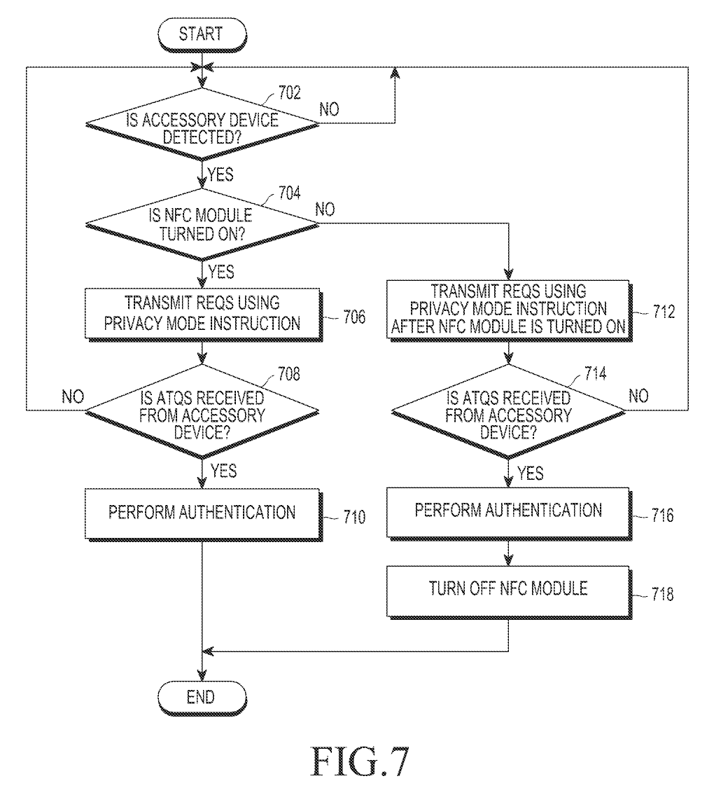

FIG. 7 is a flowchart illustrating an operation of authenticating an accessory device in an electronic device according to an embodiment of the present disclosure.

Referring to FIG. 7, in operation 702, an electronic device 101 may detect an accessory device 201. According to an embodiment, the electronic device 101 may detect whether the accessory device 201 is connected thereto, using a detection sensor 180.

When the accessory device 201 is detected, the electronic device 101 may determine whether an RF module has been turned on, in operation 704. According to an embodiment, the electronic device 101 may determine whether an NFC module has been turned on.

When it is determined that the RF module has been turned on, the electronic device 101 may transmit a REQS signal using a privacy mode instruction, in operation 706. According to an embodiment, the REQS signal for requesting authentication may be a signal supported by the accessory device 201. According to an embodiment, although the REQS signal is in the frequency band corresponding to ISO/IEC 14443 standards or ISO/IEC 15693 standards, the REQS signal may be a signal that is not defined in ISO 14443 standards or ISO/IEC 15693 standards.

In operation 708, the electronic device 101 may determine whether an ATQS signal is received from the accessory device 201. According to an embodiment, the ATQS signal for responding to the authentication request may be a prescribed signal. According to an embodiment, although the ATQS signal is in the frequency band corresponding to ISO 14443 standards or ISO/IEC 15693 standards, the ATQS signal may be a signal that is not defined in ISO 14443 standards or ISO/IEC 15693 standards.

When the ATQS signal is received, the electronic device 101 may perform authentication through communication with the accessory device 201, in operation 710.

When it is determined that the RF module has not been turned on, the electronic device 101 may turn on the RF module and then transmit the REQS signal using a privacy mode instruction, in operation 712. According to an embodiment, the REQS signal for requesting authentication may be a signal supported by the accessory device 201. According to an embodiment, although the REQS signal is in the frequency band corresponding to ISO/IEC 14443 standards or ISO/IEC 15693 standards, the REQS signal may be a signal that is not defined in ISO 14443 standards or ISO/IEC 15693 standards.

In operation 714, the electronic device 101 may determine whether an ATQS signal is received from the accessory device 201. According to an embodiment, the ATQS signal for responding to the authentication request may be a prescribed signal. According to an embodiment, although the ATQS signal is in the frequency band corresponding to ISO 14443 standards or ISO/IEC 15693 standards, the ATQS signal may be a signal that is not defined in ISO 14443 standards or ISO/IEC 15693 standards.

When the ATQS signal is received, the electronic device 101 may perform authentication through communication with the accessory device 201, in operation 716. When the authentication is completed, the electronic device 101 may turn off the RF module, in operation 718.

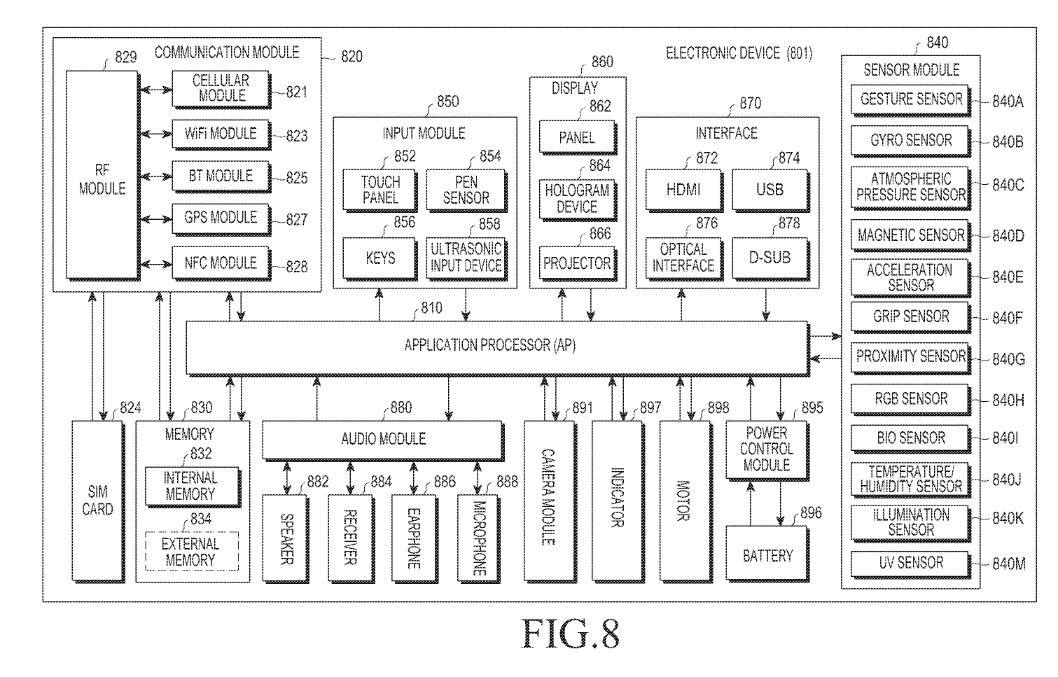

FIG. 8 is a block diagram of an electronic device according to various embodiments of the present disclosure.

Referring to FIG. 8, an electronic device 801 may constitute, for example, the entirety or a part of the electronic device 101 or the other electronic device 104 illustrated in FIG. 3. The electronic device 801 may include at least one Application Processor (AP) 810, a communication module 820, a Subscriber Identifier Module (SIM) card 824, a memory 830, a sensor module 840, an input device 850, a display 860, an interface 870, an audio module 880, a camera module 891, a power management module 895, a battery 896, an indicator 897, and a motor 898.

The AP 810 may control a plurality of hardware or software elements connected to the AP 810 by driving an operating system or an application program and process various types of data including multimedia data and perform calculations. The AP 810 may be implemented by, for example, a System on Chip (SoC). According to an embodiment, the AP 810 may further include a Graphic Processing Unit (GPU).

The communication module 820 (e.g., the communication interface 860) may transmit/receive data in communication between the electronic device 801 (e.g., the electronic device 101) and other electronic devices (e.g., the other electronic device 104 or the server 106) connected through a network. According to an embodiment, the communication module 820 may include a cellular module 821, a Wi-Fi module 823, a BT module 825, a GPS module 827, an NFC module 828, and a RF module 829.

The cellular module 821 may provide a voice call, a video call, a message service, or an Internet service through a communication network (e.g., LTE, LTE-A, CDMA, WCDMA, UMTS, WiBro, or GSM). In addition, the cellular module 821 may identify and authenticate the electronic device in a communication network using, for example, a subscriber identification module (e.g., the SIM card 824). According to an embodiment, the cellular module 821 may perform at least some functions, which the AP 810 may provide. For example, the cellular module 821 may perform at least a portion of a multimedia control function.

According to an embodiment, the cellular module 821 may include a Communication Processor (CP). In addition, the cellular module 821 may be implemented by, for example, a SoC. Although the elements, such as the cellular module 821 (e.g., the communication processor), the memory 830, and the power management module 895, are illustrated as separate components from the AP 810 in FIG. 8, the AP 810 may be implemented to include at least some (e.g., the cellular module 821) of the aforementioned elements according to an embodiment.

According to an embodiment, the AP 810 or the cellular module 821 (e.g., the communication processor) may load, in a volatile memory, instructions or data received from at least one of a non-volatile memory and other elements connected thereto and process the loaded instructions or data. In addition, the AP 810 or the cellular module 821 may store, in a non-volatile memory, data received from or created by at least one of other elements.

The Wi-Fi module 823, the BT module 825, the GPS module 827, and the NFC module 828 may include, for example, a processor for processing data transmitted/received through the corresponding module. Although the cellular module 821, the WiFi module 823, the BT module 825, the GPS module 827, and the NFC module 828 are illustrated as separate blocks in FIG. 8, at least some (e.g., two or more) of them may be contained in one Integrated Chip (IC) or one IC package according to an embodiment. For example, at least some of the processors corresponding to the cellular module 821, the WiFi module 823, the BT module 825, the GPS module 827, and the NFC module 828 (e.g., the communication processor corresponding to the cellular module 821 and the WiFi processor corresponding to the WiFi module 823) may be implemented by one SoC.

The RF module 829 may transmit/receive data, for example, an RF signal. Although not illustrated, the RF module 829 may include, for example, a transceiver, a Power Amp Module (PAM), a frequency filter, or a Low Noise Amplifier (LNA). In addition, the RF module 829 may further include a component, such as a conductor or a conductive wire, for transmitting/receiving an electromagnetic wave in a free space in wireless communication. Although the cellular module 821, the Wi-Fi module 823, the BT module 825, the GPS module 827, and the NFC module 828 share one RF module 829 in FIG. 8, at least one of them may transmit/receive an RF signal through a separate RF module according to an embodiment.

According to an embodiment, the electronic device 801 may be connected to a companion device (e.g., the other electronic device 104) through the Wi-Fi module 823, the BT module 825, or the NFC module 828. In addition, the electronic device 801 may access a base station (e.g., the server 106) through the cellular module 821 and may be connected to a host device (e.g., the electronic device 101) through the base station.

The SIM card 824 may be a card including a subscriber identification module and may be inserted into a slot formed at a particular position of the electronic device. The SIM card 824 may include unique identification information (e.g., Integrated Circuit Card IDentifier (ICCID)) or subscriber information (e.g., International Mobile Subscriber Identity (IMSI)).

The memory 830 (e.g., the memory 830) may include an internal memory 832 or an external memory 834. The internal memory 832 may include, for example, at least one of a volatile memory (e.g., a Dynamic RAM (DRAM), a Static RAM (SRAM), and a Synchronous Dynamic RAM (SDRAM)), and a non-volatile Memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and an NOR flash memory).

According to an embodiment, the internal memory 832 may be a Solid State Drive (SSD). The external memory 834 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 834 may be functionally connected to the electronic device 801 through various interfaces. According to an embodiment, the electronic device 801 may further include a storage device (or a storage medium) such as a hard disc drive.

The sensor module 840 may measure a physical quantity or detect an operation state of the electronic device 801 and convert the measured or detected information to an electronic signal. The sensor module 840 may include, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a color sensor 840H (e.g., Red, Green, and Blue (RGB) sensor), a biometric sensor 840I, a temperature/humidity sensor 840J, an illumination sensor 840K, and a Ultra Violet (UV) sensor 840M. Additionally or alternatively, the sensor module 840 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor (not illustrated), an iris sensor (not illustrated), and a fingerprint sensor (not illustrated). In addition, the sensor module 840 may include a Heart Rate Variability (HRV) sensor or a Heart Rate Monitor (HRM) sensor. The sensor module 840 may further include a control circuit for controlling at least one sensor involved therein.

The input device 850 may include a touch panel 852, a (digital) pen sensor 854, a key 856, and an ultrasonic input device 858. The touch panel 852 may recognize a touch input through at least one of a capacitive type, a resistive type, an infrared type, and an acoustic wave type. The touch panel 852 may further include a control circuit. In the case of the capacitive type, physical contact or proximity recognition is possible. The touch panel 852 may further include a tactile layer. In this case, the touch panel 852 may provide a user with a tactile reaction.

The (digital) pen sensor 854 may be implemented, for example, using the same or similar method to receiving a user's touch input or using a separate recognition sheet. The key 856 may include, for example, a physical button, an optical key, or a keypad. The ultrasonic input device 858 may detect an acoustic wave using a microphone (e.g., a microphone 888) and identify data in the electronic device 801 through an input tool for generating an ultrasonic signal and may perform wireless recognition. According to an embodiment, the electronic device 801 may also receive a user input from an external device (e.g., a computer or a server) connected thereto, using the communication module 820.

The display 860 (e.g., the display 850) may include a panel 862, a hologram device 864, and a projector 866. The panel 862 may be, for example, a Liquid Crystal Display (LCD) or an Active Matrix Organic Light Emitting Diode (AM-OLED). The panel 862 may be implemented to be, for example, flexible, transparent, or wearable. The panel 862 may be integrated with the touch panel 852. The hologram device 864 may show a stereoscopic image in the air by using interference of light. The projector 866 may project light onto a screen to display an image. The screen may be located, for example, inside or outside the electronic device 801. According to an embodiment, the display 860 may further include a control circuit for controlling the panel 862, the hologram device 864, or the projector 866.

The interface 870 may include, for example, a High-Definition Multimedia Interface (HDMI) 872, a USB 874, an optical interface 876, or a D-subminiature (D-sub) 878. The interface 870 may be included in, for example, the communication interface 160 illustrated in FIG. 3. Additionally or alternatively, the interface 870 may include, for example, a Mobile High-definition Link (MHL) interface, a SD/Multi-Media Card (MMC) interface, or an Infrared Data Association (IrDA) standard interface.

The audio module 880 may bilaterally convert a sound and an electronic signal. At least some elements of the audio module 880 may be included in, for example, the input/output interface 140 illustrated in FIG. 3. The audio module 880 may process sound information input or output through, for example, a speaker 882, a receiver 884, earphones 886, or the microphone 888.

The camera module 891 may capture still images and moving images. According to an embodiment, the camera module 891 may include one or more image sensors (e.g., a front sensor and a rear sensor), a lens (not illustrated), an Image Signal Processor (ISP) (not illustrated) or a flash (not illustrated) (e.g., an LED or a xenon lamp).

The power management module 895 may manage power of the electronic device 801. Although not illustrated, the power management module 895 may include, for example, a Power Management Integrated Circuit (PMIC), a charger IC, or a battery or fuel gauge.

The PMIC may be mounted in, for example, an integrated circuit or a SoC semiconductor. Charging methods may be classified into a wired charging method and a wireless charging method. The charger IC may charge a battery and prevent over voltage or over current from being introduced from a charger. According to an embodiment, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop, a resonance circuit, or a rectifier circuit may be added.

The battery gauge may measure, for example, a residual quantity of the battery 896, or a voltage, a current, or a temperature during the charging. The battery 896 may store or generate electricity and supply power to the electronic device 801 using the stored or generated electricity. The battery 896 may include, for example, a rechargeable battery or a solar battery.

The indicator 897 may display a particular status of the electronic device 801 or a part thereof (e.g., the AP 810), for example, a booting status, a message status, or a charging status. The motor 898 may convert an electrical signal to a mechanical vibration. Although not illustrated, the electronic device 801 may include a processing unit (e.g., a GPU) for supporting a mobile TV function. The processing unit for supporting the mobile TV may process media data according to a standard, such as Digital Multimedia Broadcasting (DMB), Digital Video Broadcasting (DVB), or media flow.

The above described components of the electronic device according to various embodiments of the present disclosure may be formed of one or more components, and a name of a corresponding component element may be changed based on the type of electronic device. The electronic device according to the present disclosure may include one or more of the aforementioned components or may further include other additional components, or some of the aforementioned components may be omitted. Further, some of the components of the electronic device according to the various embodiments of the present disclosure may be combined to form a single entity, and thus, may equivalently execute functions of the corresponding elements prior to the combination.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least part of a device (e.g., modules or functions thereof) or a method (e.g., operations) according to the various embodiments of the present disclosure may be embodied by, for example, an instruction stored in a computer readable storage medium provided in a form of a programming module. When the command is executed by one or more processors (e.g., the processor 120 in FIG. 3), the one or more processors may perform a function corresponding to the command. The computer-readable storage medium may be, for example, the memory 130 in FIG. 3. At least a part of the programming module may be implemented (e.g., executed) by, for example, the processor 120 in FIG. 3. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (e.g., programming module), such as a Read Only Memory (ROM), a Random Access Memory (RAM), a flash memory and the like. In addition, the program instructions may include high class language codes, which may be executed in a computer by using an interpreter, as well as machine codes made by a compiler. The aforementioned hardware device may be configured to operate as one or more software modules in order to perform the operation of various embodiments of the present disclosure, and vice versa.

A module or a programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments, in a storage medium storing instructions (or programs), the instructions may allow the following operations to be performed in the electronic device: an operation of detecting connection of the accessory device; an operation of transmitting a REQS signal through the RF module when the connection of the accessory device is detected; an operation of receiving, from the accessory device, an ATQS signal; and an operation of performing authentication with the accessory device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a detection sensor configured to detect a connection of an accessory device;
a radio frequency (RF) module configured to transmit and receive a radio-frequency signal; and
a processor configured:
to transmit an authentication request signal through the RF module when the connection of the accessory device is detected, and
to perform authentication with the accessory device when an authentication request response signal is received from the accessory device.

2. The electronic device of claim 1, wherein the RF module is a communication module that follows one of International Organization for Standardization (ISO)/International Engineering Consortium (IEC) 14443 standards or ISO/IEC 15693 standards.

3. The electronic device of claim 1, wherein the RF module is one of a near field communication (NFC) communication module or a radio frequency identification (RFID) module.

4. The electronic device of claim 1, wherein the authentication request signal and the authentication request response signal are signals that are not defined in International Organization for Standardization (ISO) 14443 standards and ISO/International Engineering Consortium (IEC) 15693 standards.

5. The electronic device of claim 1,
wherein the RF module comprises a first antenna configured to transmit the authentication request signal,
wherein the first antenna is disposed to overlap with a second antenna of the accessory device when the electronic device is coupled to, seated on, or connected to the accessory device.

6. An accessory device comprising:
A radio frequency (RF) module configured to transmit and receive a radio-frequency signal; and
an integrated circuit (IC) configured:
to transmit an authentication request response signal to an electronic device, and
to perform authentication with the electronic device when an authentication request signal is received from the electronic device through the RF module.

7. The accessory device of claim 6, further comprising:
a sensing body configured to enable the electronic device to detect connection between the accessory device and the electronic device.

8. The accessory device of claim 6, wherein the RF module is a communication module that follows one of International Organization for Standardization (ISO)/International Engineering Consortium (IEC) 14443 standards or ISO/IEC 15693 standards.

9. The accessory device of claim 6, wherein the RF module is one of a near field communication (NFC) communication module or a radio frequency identification (RFID) module.

10. The accessory device of claim 6, wherein the authentication request signal and the authentication request response signal are signals that are not defined in International Organization for Standardization (ISO) 14443 standards and ISO/International Engineering Consortium (IEC) 15693 standards.

11. The accessory device of claim 6,
wherein the RF module comprises a second antenna configured to receive the authentication request signal,
wherein the second antenna is disposed to overlap with a first antenna of the electronic device when the accessory device is coupled to, seated on, or connected to the electronic device.

12. A method of authenticating an accessory device in an electronic device, comprising:
detecting a connection of the accessory device;
transmitting an authentication request signal when the connection of the accessory device is detected;
receiving an authentication request response signal from the accessory device; and
performing authentication with the accessory device.

13. The method of claim 12, wherein the authentication request signal is a signal that follows one of International Organization for Standardization (ISO)/International Engineering Consortium (IEC) 14443 standards or ISO/IEC 15693 standards.

14. The method of claim 12, wherein the authentication request signal is a near field communication (NFC) signal or a radio frequency identification (RFID) signal.

15. The method of claim 12, wherein the authentication request signal and the authentication request response signal are signals that are not defined in claim 12, wherein the authentication request signal is a signal that follows one of International Organization for Standardization (ISO) 14443 standards and ISO/International Engineering Consortium (IEC) 15693 standards.

16. A non-transitory storage medium with an accessory device authentication program stored thereon, the accessory device authentication program, executed by an electronic device, performs a method comprising:
detecting a connection of the accessory device;
transmitting an authentication request signal through a radio frequency (RF) module when the connection of the accessory device is detected;
receiving an authentication request response signal from the accessory device; and
performing authentication with the accessory device.
